(19) United States
(12) Patent Application Publication
(10) Pub. No.: US 2026/0130349 A1
(43) Pub. Date: May 14, 2026

(54) DEVICE FOR MOUNTING FISHING REEL BRAKE SYSTEM

(71) Applicants: Pure Fishing, Inc., Columbia, SC (US); Jia Dun Sports Equipment Co., Ltd., Guangzhou (CN)

(72) Inventors: Yingdong QI, Guangzhou (CN); Sheng LI, Guangzhou (CN); Guohua ZANG, Guangzhou (CN); Liang HUANG, Guangzhou (CN)

(21) Appl. No.: 19/354,803

(22) Filed: Oct. 9, 2025

(30) Foreign Application Priority Data
Nov. 13, 2024 (CN) 2024116206811

(51) Int. Cl. A01K 89/0155

(52) U.S. Cl. CPC A01K 89/01555

(57) ABSTRACT

A device for mounting a brake system of a fishing reel is disclosed. The fishing reel includes a body, a first end portion, a spool portion and a brake system. The brake system is mounted to an end cover of the first end portion through the mounting device, and the mounting device includes a plurality of first snap-fit portion and a plurality of arm portions. The first snap-fit portions are arranged at the end cover. The plurality of arm portions are arranged at intervals in a circumferential direction at an opening of a mounting cavity of a mounting base of the brake system. Each arm portion extends from one end of the mounting base in an axial cantilever manner, a second snap-fit portion is provided at a tail end of each arm portion, and each second snap-fit portion is elastically snap-fitted with the respective first snap-fit portion.

### CROSS-REFERENCE TO RELATED APPLICATION

This application is based on and claims the benefit of priority from Chinese Patent Application No. 2024116206811, filed on 13 Nov. 2024, the entirety of which is incorporated by reference herein.

### TECHNICAL FIELD

The present disclosure relates to the technical field of fishing reels, and in particular to a device for mounting a fishing reel brake system.

### BACKGROUND

In a fishing reel, such as a baitcasting reel, excessive spool rotation speed during a cast can cause the line to leave the spool faster than the lure travels. This causes the line to bunch up around the spool, resulting in “backlash”. To prevent this, a brake system is mounted that applies braking force to the spool. In such brake system, the braking force is generated through cooperation between a coil and a magnet. Furthermore, the magnitude of the braking force may be adjusted through a circuit board.

Since fishing reels are constantly exposed to water during use, the brake system of the fishing reels must be sealed to prevent water entering the brake system, which could cause short circuits or other failures. In order to avoid water ingress in the brake system, for example, in patent reference 1, a coil and a circuit board are mounted in an accommodating cavity of a brake housing, and the accommodating cavity is sealed, and then fastened to a spool by a fastening member such as a screw which passes through a mounting hole. Because the mounting hole of the brake housing is separated from the accommodating cavity, water or other impurities can be prevented from entering the accommodating cavity through the mounting hole, offering effective protection.

However, in patent reference 1, the mounting hole is formed at a flange end of the brake housing. Because the flange end is thin, the flange end of the brake housing may crack due to excessive fastening force or large impact on the fishing reel during the process of mounting the brake housing or using the fishing reel. Moreover, with expansion of a crack position, the crack will extend to the accommodating cavity of the brake housing, which will lead to water entering the accommodating cavity. In the case of water entering in the accommodating cavity, the brake system may also be short-circuited and ineffective.

### PRIOR ART REFERENCES

### Patent references

Patent reference 1: China Utility Model Publication No. 220068621

### SUMMARY

In view of the above technical problems, the present disclosure aims at providing a device for mounting a brake system of a fishing reel, which can improve the sealing reliability of the brake system while mounting the brake system of the fishing reel to an end cover of the fishing reel.

In the device for mounting a brake system of a fishing reel according to the present disclosure, the fishing reel comprises: a body, a first end portion, a spool portion and a brake system.

The first end portion is provided with an end cover, and the end cover is mounted at an axial end of the body.

The spool portion is provided with a spool shaft, and an axial end of the spool shaft is rotatably mounted on the end cover.

The brake system is mounted to the end cover, and the brake system is provided with a mounting base, a coil, a magnet and a control panel, wherein the mounting base is provided with a mounting cavity, the coil is mounted on the mounting cavity, the magnet is mounted on the spool shaft, and the coil and the magnet are opposite to each other along a radial direction of the spool shaft.

The brake system is mounted to the end cover through the mounting device, and the mounting device comprises: a plurality of first snap-fit portions and a plurality of arm portions. The first snap-fit portions are arranged at the end cover. The plurality of arm portions are arranged at intervals in a circumferential direction at an opening of the mounting cavity of the mounting base. Each of the arm portions extends from one end of the mounting base in an axial cantilever manner, a second snap-fit portion is provided at a tail end of each of the arm portions, and each second snap-fit portion is elastically snap-fitted with the respective first snap-fit portion.

The device for mounting a brake system of a fishing reel according to the present disclosure has the beneficial effects of improving the sealing reliability of the brake system while mounting the brake system of the fishing reel to the end cover of the fishing reel.

In some embodiments, the mounting base is provided with an annular first wall portion located at a radial inner side; an annular second wall portion surrounding a radial outer side of the first wall portion; and a sealing wall connected with the first wall portion and the second wall portion at a side opposite to the opening in the axial direction; wherein the first wall portion, the second wall portion and the sealing wall together define the mounting cavity; and the arm portions are arranged on the second wall portion.

In some embodiments, a transition groove is provided between each of the arm portions and the second wall portion.

In some embodiments, each of the first snap-fit portions is a snap-fit groove extending through the end cover in a thickness direction of the end cover; each of the second snap-fit portions is a jaw at the tail end of the respective arm portion; and the jaw served as the respective second snap-fit portion passes through the snap-fit groove served as the respective first snap-fit portion and is snap-fitted with the end cover at a side opposite to the mounting base.

In some embodiments, the snap-fit groove is provided in plural; and a length of each of the snap-fit grooves is identical to a width of each of the arm portions where the jaw snap-fitted with the snap-fit groove is provided.

In some embodiments, the end cover is provided with a first guide surface at a side of each of the snap-fit grooves opposite to the mounting base; and each of the arm portions is elastically deformed by sliding the respective jaw along the respective first guide surface, and is abutted against the respective snap-fit groove in a direction opposite to an elastic deformation direction of the arm portion after the respective jaw passes through the respective snap-fit groove.

In some embodiments, in a state that each of the second snap-fit portions is snap-fitted with the respective first snap-fit portion, the mounting base and the end cover are abutted against each other at two opposite ends in the axial direction.

In some embodiments, the mounting device further comprises a sealing layer sealing the opening of the mounting cavity; and a cover plate accommodated in the mounting cavity and covering the control panel, wherein the cover plate does not protrude from the opening of the mounting cavity; wherein, the sealing layer comprises a filling layer, the filling layer fills a gap between a circumferential edge of the cover plate and the mounting cavity, and the filling layer does not protrude from the opening of the mounting cavity.

In some embodiments, one end of the spool shaft passes through the mounting base and the cover plate in the axial direction and is mounted on the end cover; the first wall portion defines a first avoidance hole allowing the spool shaft to pass through; a second avoidance hole allowing the first wall portion to be inserted is provided in a middle portion of the cover plate; and the sealing layer comprises a first sealing ring, and the first sealing ring is arranged between the first wall portion and the second avoidance hole.

In some embodiments, the control panel is provided with a braking-dial input portion; the cover plate is provided with a third avoidance hole opposite to the braking-dial input portion; a connecting shaft for switching a braking-dial switch and connected with the braking-dial input portion passes through the third avoidance hole and is connected with the braking-dial input portion; and the sealing layer comprises a second sealing ring, and the second sealing ring is arranged between the connecting shaft and the third avoidance hole.

### BRIEF DESCRIPTION OF THE DRAWINGS

FIG. 1 is a perspective view of a fishing reel of the present disclosure as viewed from a second end portion.

FIG. 2 is a perspective view of the fishing reel of the present disclosure as viewed from a first end portion.

FIG. 3 is a sectional view of a brake system of a fishing reel according to an embodiment of the present disclosure.

FIG. 4 is a schematic diagram of a device for mounting a brake system in the sectional view of FIG. 3.

FIG. 5 is an enlarged view of a portion A shown in FIG. 4.

FIG. 6 is a perspective view of an end cover of the first end portion of the fishing reel as viewed from an axial outer side according to an embodiment.

FIG. 7 is a perspective view of the end cover of the first end portion of the fishing reel as viewed from an axial inner side according to an embodiment.

FIG. 8 is a perspective view of a mounting base of the brake system of the fishing reel according to an embodiment.

### REFERENCE NUMERALS

101—body; 102—first end portion; 103—second end portion; 104—spool portion; 105—handle; 106—brake system; 107—shaft supporting portion; 107a—first bearing; 108—spool shaft; 109—spool cylinder; 111—end cover; 112—side cover; 113—mounting base; 114—coil, 115—magnet; 116—control panel; 117—braking-dial input portion; 118—knob; 120—connecting shaft; 121—base portion; 122—outer side wall; 122a—inner side wall surface; 123—middle wall; 124—mounting lug; 125—accommodating cavity; 127—space; 147—mounting cavity; 154—cover plate; 155—first wall portion; 156—second wall portion; 157—sealing wall; 158—opening; 159—first avoidance hole; 160—second avoidance hole; 161—third avoidance hole; 162—mounting device; 163—sealing layer; 164—first snap-fit portion; 165—arm portion; 166—second snap-fit portion; 167—snap-fit groove; 168—first inner side surface; 169—second inner side surface; 170—third inner side surface; 171—fourth inner side surface; 172—first guide surface; 173—first surface; 174—second surface; 175—third surface; 176—fourth surface; 177—jaw; 178—abutting surface; 179—opening side end surface; 180—second guide surface; 181—transition groove; 182—gluing layer; 183—filling layer; 184—first sealing ring; and 185—second sealing ring.

### DETAILED DESCRIPTION

Embodiments of the present disclosure will be described in detail below. Examples of the embodiments are illustrated in the accompanying drawings, where the same or like reference numerals throughout the figures indicate the same or like elements having the same or like functions. The embodiments described below with reference to the accompanying drawings are exemplary and are intended only to explain the present disclosure instead of being construed as limiting the present disclosure.

In the description of the present disclosure, it should be understood that, descriptions relating to orientation, for example, orientation or positional relationships indicated by “up”, “down”, “front”, “rear”, “left”, “right”, etc. are based on the orientation or positional relationships shown in the accompanying drawings, and are to facilitate the description of the present disclosure and simplify the description only, rather than indicating or implying that the device or element referred to must have a specific orientation or be constructed and operated in a specific orientation, and therefore cannot be construed as limiting the present disclosure.

In the description of the present disclosure, the meaning of “several” is one or more, the meaning of “a plurality of” is two or more, “greater than”, “less than”, “more than”, etc. are to be understood to exclude the given figure, and “above”, “below”, “within”, etc. are understood to include the given figure. If “first” and “second”, etc. are referred to, it is only for the purpose of distinguishing technical features, and shall not be understood as indicating or implying relative importance or implying the number of the indicated technical features or implying the sequence of the indicated technical features.

In the description of the present disclosure, unless otherwise explicitly defined, the words such as “set”, “install”, and “connect” should be understood in a broad sense, and those of ordinary skill in the art can determine the specific meanings of the above words in the present disclosure in a rational way in combination with the specific contents of the technical solutions.

In addition, in the description of the present disclosure, when referring to the description about a shaft and a hole, “same” refers to a fit relationship of the shaft and the hole based on machinery; when referring to the description about diameter, radius, distance, thickness, and the like, “same” refers to the same fit relationship based on machinery, and may have an allowable error (tolerance) for a certain assembly relationship (such as clearance fit). When referring to the description about an axial direction, it refers to an axial direction of a spool shaft. When referring to the description about an outer side and an inner side, with a center of a cross section of an axial middle portion of the spool shaft as a reference, a side farther away from the center in the radial or axial direction of the spool shaft is regarded as the “outer side”, and a side closer to the center in the radial or axial direction is regarded as the “inner side”.

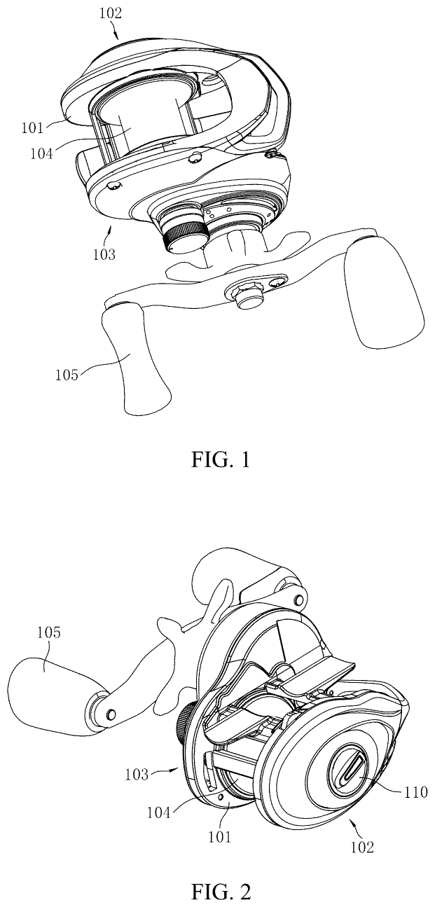

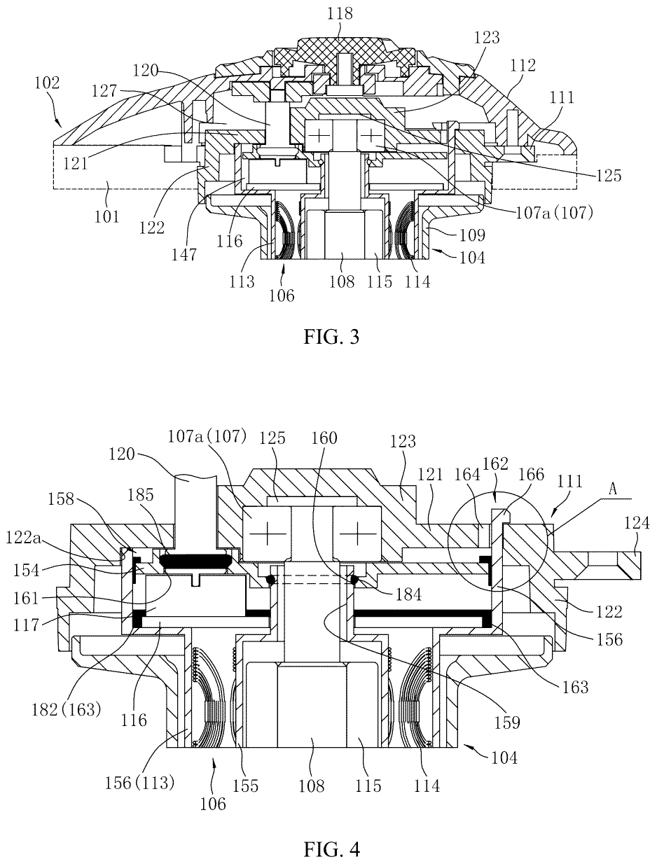

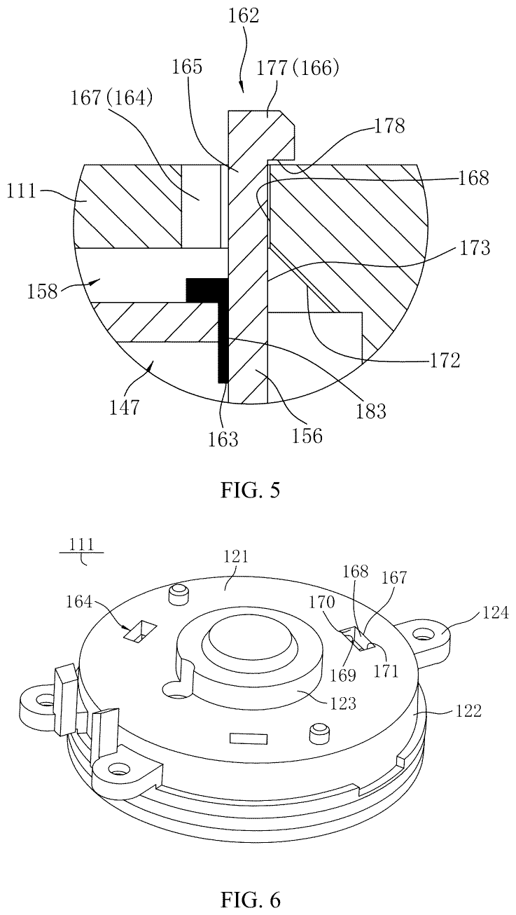

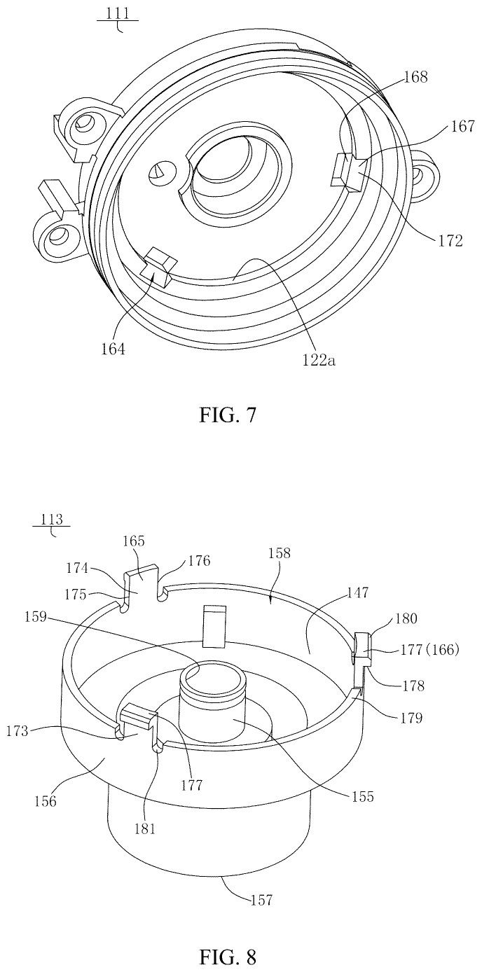

FIG. 1 is a perspective view of a fishing reel of the present disclosure as viewed from a second end portion 103. FIG. 2 is a perspective view of a fishing reel as viewed from a first end portion 102. FIG. 3 is a sectional view of a brake system 106 of the fishing reel. In FIG. 3, a section is taken along an axis of a spool shaft 108. In addition, for convenience of illustration, this figure mainly illustrates the structures on the side of the first end portion 102. FIG. 4 is a schematic diagram that simplifies FIG. 3 and mainly illustrates a mounting device 162 of the brake system 106. FIG. 5 is an enlarged view of a portion A shown in FIG. 4. FIG. 6 and FIG. 7 are perspective views of an end cover 111. FIG. 8 is a schematic diagram of a mounting base 113 of the brake system 106.

Referring to FIG. 1 to FIG. 8, and mainly referring to FIG. 1 to FIG. 3, a fishing reel according to an embodiment of the present disclosure is described. The fishing reel according to the embodiment, for example, may be a baitcasting reel, and a rotation speed of the spool shaft 108 is controlled by electromagnetic braking.

The fishing reel according to the embodiment comprises a body 101, a first end portion 102, a second end portion 103, a spool portion 104, a handle 105, a rotation transmission mechanism for transmitting a rotation motion of the handle 105 to the spool portion 104, and a brake system 106 for braking rotation of the spool portion 104. The body 101 serves as a whole frame to support the fishing reel. The first end portion 102 is mounted at an axial end of the body 101, and furthermore, the brake system 106 is mainly mounted at the first end portion 102. The second end portion 103 is mounted at the other axial end of the body 101, and furthermore, the rotation transmission mechanism (not shown) is accommodated in the second end portion 103. The handle 105 is mounted on an axial outer side of the second end portion 103 (that is, the side opposite to the body 101), and the handle 105 is in transmission connection with the spool portion 104 via the rotation transmission mechanism. A specific structure of the rotation transmission mechanism may be, for example, a well-known gear transmission mechanism of the existing fishing reel, so the structure will not be described in detail here. The spool portion 104 is rotatably mounted on the first end portion 102 and the second end portion 103 through a shaft supporting portion 107. The shaft supporting portion 107 is provided with a first bearing 107a and a second bearing, the first bearing 107a is mounted at the first end portion 102, and the second bearing is mounted at the second end portion 103 coaxially with the first end portion 102. The spool portion 104 is provided with a spool shaft 108 and a spool cylinder 109 coaxially sleeved over the spool shaft 108 and rotating together with the spool shaft 108, and the spool shaft 108 of the spool portion 104 and the handle 105 are connected via the rotation transmission mechanism. In addition, both axial ends of the spool shaft 108 are rotatably mounted on the first bearing 107a and the second bearing respectively, so that when the handle 105 rotates, the spool shaft 108 and the spool cylinder 109 rotate together. A fishing line is wound around the spool cylinder 109, and the fishing line is retrieved or released with the rotation of the spool cylinder 109.

The first end portion 102 is provided with an end cover 111 and a side cover 112. The end cover 111 is generally disc-shaped when viewed from the top, and may be mounted to the side cover 112 by a well-known connecting structure such as screw connection, and the side cover 112 covers the end cover 111 from an outer side of the end cover 111 and may be mounted to the body 101 by a snap-fit method, for example. In this way, the first end portion 102 is mounted to the body 101.

With continued reference to FIG. 6 and FIG. 7, and with auxiliary reference to FIG. 3 to FIG. 4, the side cover 112 is provided with a base portion 121, an outer side wall 122 and a middle wall 123, which are integrally formed. The base portion 121 has a substantially annular flat-plate shape. The outer side wall 122 surrounds the base portion 121 and protrudes from the base portion 121 in a direction perpendicular to the base portion 121. For example, the outer side wall 122 is formed to extend toward an axial middle portion of the body 101 in a state that the end cover 111 is mounted to the side cover 112. The outer side wall 122 is formed with a plurality of mounting lugs 124 at intervals in a circumferential direction, and the end cover 111 is mounted to the side cover 112 via these mounting lugs 124. An annular inner side wall surface 122a is formed at a radial inner side of the outer side wall 122, and an inner diameter of the inner side wall surface 122a is the same as an outer diameter of a second wall portion 156 (described later) of a mounting base 133 (described later). Furthermore, the inner side wall surface 122a is connected with the base portion 121 at the inner side. The middle wall 123 is formed in a middle portion of the base portion 121. Starting from the base portion 121, the middle wall 123 protrudes from the base portion 121 in the axial direction, that is, both ends of the middle wall 123 protrude from the base portion 121 in the axial direction. An axial end of the middle wall 123 extends toward the axial middle portion of the body 101, and the other axial end of the middle wall 123 extends toward an outer side of the body 101. An accommodating cavity 125 is formed at an inner side of the middle wall 123, and the first bearing 107a of the shaft supporting portion 107 for supporting an axial end of the spool shaft 108 is embedded in the accommodating cavity 125. Furthermore, one end of the middle wall 123 extending toward the outer side of the body 101 is sealed.

Referring to FIG. 3, a knob 118 is rotatably mounted on the side cover 112, and the knob 118 is connected with a braking-dial input portion 117 (described later) of a control panel 116 (described later) of the brake system 106 via a connecting shaft 120 accommodated in a space 127 formed between the side cover 112 and the end cover 111. Thus, a level of a braking force is adjusted by rotating the knob 118.

With continued reference to FIG. 3, FIG. 4 and FIG. 8, the brake system of the fishing reel 106 is mainly mounted at the first end portion 102. The brake system 106 is provided with a mounting base 113, a coil 114, a magnet 115, a control panel 116 and a cover plate 154.

The mounting base 113 is provided with an annular first wall portion 155 located at a radial inner side, an annular second wall portion 156 surrounding a radial outer side of the first wall portion 155, and a sealing wall 157 connected with the first wall portion 155 and the second wall portion 156 at one end of the first wall portion 155 and one end of the second wall portion 156 in the axial direction near a middle portion of the body 101. The first wall portion 155, the second wall portion 156 and the sealing wall 157 together define a mounting cavity 147. The mounting cavity 147 has an opening 158, which is located opposite to the sealing wall 157 in the axial direction. When mounted to the end cover 111, the opening 158 of the mounting cavity 147 faces the end cover 111. The first wall portion 155 is cylindrical as a whole, and the first wall portion 155 defines a first avoidance hole 159 in the axial direction that allows the spool shaft 108 to pass through.

The coil 114 and the control panel 116 are mounted in the mounting cavity 147. A plurality of coils 114 are provided, for example, which are attached to one side of the first wall portion 155 and one side of the second wall portion 156 located in the mounting cavity 147 at intervals along a circumferential direction of the first wall portion 155. The control panel 116 is coaxially sleeved over the first wall portion 155. The control panel 116 is provided with a braking-dial input portion 117, and the braking-dial input portion 117 is configured for switching a level of a braking force generated by the coils 114 and the magnet 115. The braking-dial input portion 117 comprises, for example, braking-dial switches (braking-dial resistors) arranged at the control panel 116. By rotating these braking-dial switches, their on-time or resistance value is varied, thereby adjusting the level of the braking force.

The cover plate 154 is accommodated in the mounting cavity 147 and covers the control panel 116. The cover plate 154 does not protrude from the opening 158 of the mounting cavity 147. An outer diameter of the cover plate 154 is slightly smaller than an inner diameter of the opening 158 of the mounting cavity 147. A second avoidance hole 160 allowing the first wall portion 155 to be inserted is formed in a radial middle portion of the cover plate 154, and the cover plate 154 is coaxially sleeved over the first wall portion 155 through the second avoidance hole 160. A third avoidance hole 161 is formed in the cover plate 154 at a position corresponding to the braking-dial input portion 117 of the control panel 116, and the connecting shaft 120 connected with the braking-dial input portion 117 for switching the braking-dial switches passes through the third avoidance hole 161 and is connected to the braking-dial input portion 117.

In an assembled state, the brake system 106 is mounted to an axial inner side of the end cover 111 through the mounting base 113. The spool shaft 108 of the spool portion 104 passes through the first avoidance hole 159 defined by the first wall portion 155 and is mounted on the first bearing 107a in the accommodating cavity 125 of the end cover 111. Thus, the assembly of the fishing reel at the first end portion 102 is completed.

With continued reference to FIG. 4 and FIG. 5 and with auxiliary reference to FIG. 6 to FIG. 8, in order to prevent liquid such as water from entering the mounting cavity 147 of the mounting base 113, thereby causing short circuit and failure of the brake system 106, in the mounting device 162 for the brake system 106 of the fishing reel according to the embodiment, the opening 158 of the mounting cavity 147 is sealed by a sealing layer 163. Thereby, liquid such as water is prevented from entering the mounting cavity 147. In addition, in order to prevent cracking of the mounting base 113, the mounting device 162 is further provided with a first snap-fit portion 164 and a plurality of arm portions 165 each formed with a respective second snap-fit portion 166. The first snap-fit portion 164 is formed in the end cover 111. The plurality of arm portions 165 are formed at intervals in a circumferential direction at the opening 158 of the mounting cavity 147 of the mounting base 113, and each arm portion 165 extends axially from one end of the mounting base 113 in a cantilever fashion. A second snap-fit portion 166 is formed at a tail end of the arm portion 165, and the second snap-fit portion 166 and the first snap-fit portion 164 are elastically snap-fitted with each other.

The mounting device 162 of the brake system 106 in the embodiment can keep water out of the brake system 106 of the fishing reel for a longer time, thereby improving the sealing reliability of the brake system 106 of the fishing reel. Specifically, by forming the first snap-fit portion 164 on the end cover 111 and the second snap-fit portion 166 on the mounting base 113, snap-fit connection between the first snap-fit portion 164 and the second snap-fit portion 166 eliminates the need for screw-fastening, thereby avoiding excessive fastening force on the mounting base 113. Furthermore, by extending the arm portion 165 from the opening 158 of the mounting cavity 147 of the mounting base 113 in a cantilever manner, the elasticity of the arm portion 165 can be improved, and the elasticity at a position where the first snap-fit portion 164 is snap-fitted with the second snap-fit portion 166 can be improved. Even if the mounting base 113 is impacted, the impact force can be absorbed by the arm portion 165, thereby suppressing the cracking of the mounting base 113. Moreover, since the arm portion 165 is cantilever-shaped, even if a crack occurs, the crack does not easily extend to a part of the mounting base 113 where the mounting cavity 147 is formed along a length direction of the arm portion 165. Therefore, the mounting device 162 of the brake system 106 in the embodiment can improve the sealing reliability of the brake system 106 of the fishing reel.

Referring to FIG. 6, for example, a plurality of first snap-fit portions 164 are formed along a circumferential direction of the end cover 111, and the first snap-fit portions 164 are snap-fit grooves 167 extending through the end cover 111 along a thickness direction (i.e., the axial direction) of the end cover 111. The snap-fit grooves 167 are formed by extending through the base portion 121 of the end cover 111. Three snap-fit grooves 167 may be provided, which are evenly distributed along a circumferential direction of the base portion 121, and certainly, it is not limited to this. The number and distribution of the snap-fit grooves 167 may be appropriately adjusted. Cross-sectional shapes of the snap-fit grooves 167 are almost the same. Therefore, for convenience here, only the specific structure of one snap-fit groove 167 will be described, and other snap-fit grooves 167 will be mentioned if necessary. The cross section of the snap-fit groove 167 is generally rectangular. The snap-fit groove 167 is provided with a first inner side surface 168 and a second inner side surface 169 located in the radial direction of the end cover 111, as well as a third inner side surface 170 and a fourth inner side surface 171 located in the circumferential direction of the end cover 111. The first inner side surface 168 is located near the outer side wall 122 in the radial direction of the end cover 111. The first inner side surface 168 is arc-shaped, and a radius of the first inner side surface 168 is the same as that of an inner side wall surface 122a of the outer side wall 122, and the first inner side surface 168 is in smooth transition with the inner side wall surface 122a. In addition, a radius of the first inner side surface 168 is substantially the same as a radius of a radial outer side surface of the second wall portion 156 of the mounting base 113. In other words, an outer diameter of a virtual circle defined by the first inner side surfaces 168 of the plurality of snap-fit grooves 167 is the same as an outer diameter of the second wall portion 156. The second inner side surface 169 is opposite to the first inner side surface 168 and is located closest to the middle wall 123 in the radial direction of the end cover 111. The third inner side surface 170 and the fourth inner side surface 171 are opposite to each other and connected with the first inner side surface 168 and the second inner side surface 169 respectively.

Referring to FIG. 7, a first guide surface 172 is formed on the inner surface of the end cover 111 (that is, the side of the snap-fit groove 167 opposite to the mounting base 113), and the first guide surface 172 is connected with the first inner side surface 168 of the snap-fit groove 167. The first guide surface 172 is inclined from an axial inner edge of the first inner side surface 168 toward the inner side wall surface 122a of the outer side wall 122. The first guide surface 172 may be inclined in a planar manner, that is, the first guide surface 172 may be an inclined surface. Furthermore, the first guide surface 172 may also be inclined in an arc manner, that is, the first guide surface 172 may be an arc surface.

Referring to FIG. 8, there may also be three arm portions 165 corresponding to the number of the snap-fit grooves 167, and the arm portions 165 are formed on an end surface of the second wall portion 156 of the mounting base 113. Each of the arm portions 165 is provided with a first surface 173 which is in smooth transition with the radial outer side surface of the respective second wall portion 156. The first surface 173 is arc-shaped and has the same outer diameter as the radial outer side surface of the second wall portion 156. That is, a radius of the first surface 173 is also the same as a radius of the first inner side surface 168 of the snap-fit groove 167. An outer diameter of a virtual circle defined by the first surfaces 173 of the plurality of arm portions 165 is the same as the outer diameter of the second wall portion 156. In other words, the outer diameter of the virtual circle defined by the first surfaces 173 of the plurality of arm portions is the same as the outer diameter of the virtual circle defined by the first inner side surfaces 168 of the plurality of snap-fit grooves 167. Each of the arm portions 165 is provided with a second surface 174 which is in smooth transition with a radial inner side surface of the respective second wall portion 156, and the second surface 174 and the first surface 173 are opposite in the radial direction of the mounting base 113. In addition, the arm portion 165 is further provided with a third surface 175 and a fourth surface 176. The third surface 175 and the fourth surface 176 are opposite to each other along a circumferential direction of the outer side wall 122. A distance between the third surface 175 and the fourth surface 176 (that is, a width of the arm portion 165) is the same as a distance between the third inner side surface 170 and the fourth inner side surface 171 of the snap-fit groove 167 (that is, a length of the snap-fit groove 167). However, for the convenience of assembly, there is a dimensional relationship of clearance fit between the width of the arm portion 165 and the length of the snap-fit groove 167 (for example, the length of the snap-fit groove 167 may be larger than the width of the arm portion 165 by 0.1 mm to 0.3 mm).

The tail end of the arm portion 165 is formed with a jaw 177 for snap-fitting with the first snap-fit portion 164. In a snap-fit state, the jaw 177 served as the second snap-fit portion 166 passes through the snap-fit groove 167 served as the first snap-fit portion 164 and is snap-fitted with the outer side (the side opposite to the mounting base 113) of the end cover 111. The jaw 177 extends from the tail end of the arm portion 165 substantially parallel to a radial direction of the mounting base 113 to a radial outer side of the mounting base 113. A distance between the second surface 174 of the arm portion 165 of the jaw 177 and a tail end of the jaw 177 that is located more outside than the first surface 173 of the arm portion 165 (i.e., a length of the jaw 177) is the same as a distance between the first inner side surface 168 and the second inner side surface 169 of the snap-fit groove 167 (i.e., a width of the snap-fit groove 167). However, for the convenience of assembly, there is a dimensional relationship of clearance fit between the length of the jaw 177 and a width of the snap-fit groove 167 (for example, the width of the snap-fit groove 167 may be larger than the length of the jaw 177 by 0.1 mm to 0.3 mm).

The jaw 177 is provided with an abutting surface 178 opposite to an opening side end surface 179 of the second wall portion 156, and a distance between the abutting surface 178 and the opening side end surface 179 in the axial direction of the mounting base 113 is the same as a thickness of the base portion 121 of the end cover 111. However, for the convenience of assembly, there is a dimensional relationship of clearance fit between the distance and the thickness (for example, the distance between the abutting surface 178 and the opening side end surface 179 may be larger than the thickness of the base portion 121 of the end cover 111 by 0.1 mm to 0.3 mm). In other words, when the jaw 177 passes through the snap-fit groove 167 and is clamped at the outer side of the end cover 111, the abutting surface 178 of the jaw 177 and the opening side end surface 179 of the second wall portion 156 clamp and abut against the base portion 121 of the end cover in the axial direction. That is, in the state where the jaw 177 served as the second snap-fit portion 166 and the snap-fit groove 167 served as the first snap-fit portion 164 are snap-fitted with each other, two opposite ends of the mounting base 113 and the end cover 111 are abutted against each other. In this way, the mounting base 113 is prevented from shaking in the axial direction relative to the end cover 111.

The jaw 177 is formed with a second guide surface 180 on the side opposite to the abutting surface 178, and the second guide surface 180 may be an inclined surface or an arc surface. The second guide surface 180 may be a guide surface formed by chamfering or rounding a tail end of the jaw 177.

In addition, a transition groove 181 is formed between the arm portion 165 and the second wall portion 156. More specifically, the arm portion 165 is respectively formed with the transition groove 181 between the third surface 175 and the opening side end surface 179 of the second wall portion 156 and between the fourth surface 176 and the opening side end surface 179 of the second wall portion 156. At least a bottom surface of the transition groove 181 is an arc surface. Through the transition groove 181, the arm portion 165 can be elastically deformed more easily relative to the second wall portion 156. Even under slightly greater deflection, stress concentration is not easy to occur, thereby suppressing the mounting base 113 from cracking at the connection between the arm portion 165 and the second wall portion 156.

With continued reference to FIG. 4 to FIG. 8, assembly and disassembly of the mounting base 113 relative to the end cover 111 will be described below.

During assembly, first, the jaws 177 of the arm portions 165 of the mounting base 113 are respectively aligned with the snap-fit grooves 167 of the base portion 121 of the end cover 111. Then, the mounting base 113 is pushed in the axial direction. In this case, each of the arm portions 165 is elastically deformed toward the radial inner side of the mounting base 113 by sliding the respective jaw 177 along the respective first guide surface 172. The mounting base 113 is pushed continuously, so that each jaw 177 passes through the respective snap-fit groove 167 in the axial direction. In this case, an outer periphery surface of the second wall portion 156 of the mounting base 113 and the inner side wall surface 122a of the outer side wall 122 of the end cover 111 are matched with each other, and the opening side end surface 179 of the second wall portion 156 of the mounting base 113 abuts against an axial inner side of the base portion 121 of the end cover 111. Furthermore, after the jaws 177 pass through the respective snap-fit grooves 167, the arm portions 165 return to the radial outer side of the mounting base 113, and the side of each arm portion 165 opposite to the elastic deformation thereof (i.e., the first surface 173) faces the outer side (i.e., the direction opposite to the elastic deformation thereof) and is abutted against the respective snap-fit groove 167 (i.e., the first inner surface 168). In this way, the mounting base 113 is mounted on the end cover 111.

During disassembly, the arm portions 165 of the mounting base 113 are elastically deformed toward the radial inner side of the mounting base 113 from the axial outer side of the end cover 111, and at the same time, the arm portions 165 of the mounting base 113 are pushed toward the axial inner side of the end cover 111, so that the mounting base 113 can be disassembled.

With continued reference to FIG. 4, the sealing layer 163 for the opening 158 of the mounting cavity 147 is explained hereinafter.

As described above, the opening 158 of the mounting cavity 147 is sealed by the sealing layer 163. In addition, the brake system is provided with the cover plate 154. The cover plate 154 is accommodated in the mounting cavity 147 and covers the control panel 116. In the mounting device 162 of the brake system 106 in the embodiment, the opening 158 of the mounting cavity 147 can be sealed by a plurality of sealing layers 163. For example, among the sealing layers 163 of the mounting device 162, there is a sealing layer (also called “gluing layer 182”) covering an area of the control panel 116 except the braking-dial input portion 117. After the control panel 116 is mounted in the mounting cavity 147, the braking-dial input portion 117 of the control panel 116 can be covered, and then the mounting cavity 147 is filled with glue, thereby forming the gluing layer 182 directly covering the control panel 116 except the braking-dial input portion 117.

For example, among the sealing layers 163 of the mounting device 162, there is a filling layer 183. The filling layer 183 fills a gap between a circumferential edge of the cover plate 154 and a wall surface of the mounting cavity 147 (that is, an inner side surface of the second wall portion 156), thereby sealing the opening 158 of the mounting cavity 147. Specifically, while the cover plate 154 is accommodated in the mounting cavity 147, the third avoidance hole 161 of the cover plate 154 is aligned with the braking-dial input portion 117 of the control panel 116 and then the control panel 116 is covered. Next, the gap between the cover plate 154 and the wall surface of the mounting cavity 147, that is, the inner side surface of the second wall portion 156, is filled, thereby forming the filling layer 183 filled in the gap, for example, a filling layer made of a resin material. The filling layer 183 does not protrude from the opening 158 of the mounting cavity 147, so as to prevent the opening side end surface 179 of the second wall portion 156 of the mounting base 113 from cracking, which would unfavorably affect the sealing performance of the filling layer 183.

In addition, as mentioned above, one end of the spool shaft 108 passes through the mounting base 113 and the cover plate 154 in the axial direction and is mounted on the end cover 111. A cylindrical first wall portion 155 is formed in a middle portion of the mounting base 113, and the first wall portion 155 defines the first avoidance hole 159 allowing the spool shaft 108 to pass through. The second avoidance hole 160 allowing the first wall portion 155 to be inserted is formed in the middle portion of the cover plate 154. In order to seal a gap between the cover plate 154 and the first wall portion 155, the sealing layers 163 of the mounting device 162 comprise a first sealing ring 184, and the first sealing ring 184 is arranged between the first wall portion 155 and the second avoidance hole 160. The first sealing ring 184 may be, for example, an O-ring.

Further, as described above, the control panel 116 is provided with the braking-dial input portion 117. The third avoidance hole 161 is formed in the cover plate 154 at a position opposite to the braking-dial input portion 117. The connecting shaft 120 connected to the braking-dial input portion 117 for switching the braking-dial switch passes through the third avoidance hole 161 and is connected with the braking-dial input portion 117. In order to seal the gap between the cover plate 154 and the connecting shaft 120, the sealing layers 163 of the mounting device 162 comprise a second sealing ring 185, and the second sealing ring 185 is arranged between the connecting shaft 120 and the third avoidance hole 161. Similarly, the second sealing ring 185 may be an O-ring.

In the mounting device 162 of the embodiment, the first snap-fit portion 164 is formed on the end cover 111 and the second snap-fit portion 166 is formed on the mounting base 113, and the first snap-fit portion 164 and the second snap-fit portion 166 are snap-fitted with each other, so that it is possible to avoid screw-fastening, thereby avoiding excessive fastening force on the mounting base 113.

Furthermore, by extending the arm portion 165 from the opening 158 of the mounting cavity 147 of the mounting base 113 in a cantilever manner, the elasticity of the arm portion 165 can be improved, and the elasticity of the position where the first snap-fit portion 164 is snap-fitted with the second snap-fit portion 166 can be improved. Even if the mounting base 113 is impacted, the impact force can be absorbed by the arm portion 165, thereby suppressing the cracking of the mounting base 113.

Moreover, since the arm portion 165 is cantilever-shaped, even if a crack occurs, the crack does not easily extend to a part of the mounting base 113 where the mounting cavity 147 is formed in the length direction of the arm portion 165.

Further, by preventing the filling layer 183 filling the gap between the cover plate 154 and the mounting cavity 147 from protruding out of the opening 158 of the mounting cavity 147, even if a crack appears on the opening side end surface 179 of the second wall portion 156 of the mounting base 113, the sealing performance of the filling layer 183 can be suppressed from being affected by the crack.

Therefore, the mounting device 162 of the brake system 106 in the embodiment can suppress the water from entering the brake system 106 of the fishing reel for a longer time, thereby improving the sealing reliability of the brake system 106 of the fishing reel.

In the mounting device 162 of the embodiment, the arm portion 165 is formed on the second wall portion 156 of the mounting base 113, and the transition grooves 181 are formed between the second wall portion 156 and the arm portion 165, so that the elastic performance of the arm portion 165 can be improved, and the arm portion 165 can be more easily elastically deformed relative to the second wall portion 156. Even under slightly greater deflection, stress concentration is not easy to occur, thereby suppressing the mounting base 113 from cracking at the connection between the arm portion 165 and the second wall portion 156.

In the mounting device 162 of the embodiment, the snap-fit groove 167 served as the first snap-fit portion 164 is formed in the end cover 111, and the jaw 177 served as the second snap-fit portion 166 is formed at the tail end of the arm portion 165, so that the mounting base 113 of the brake system 106 can be assembled or disassembled more easily. For example, when assembling, it is only necessary to elastically deform the arm portion 165 so that the jaw 177 can pass through the snap-fit groove 167. Similarly, during disassembly, it is only necessary to elastically deform the arm portion 165, so that the arm portion 165 can be pulled out from the snap-fit groove 167. No additional disassembly tool is needed.

In addition, since the mounting base 113 is also disassembled from the axial outer side of the end cover 111, the convenience of disassembly can be further improved.

In the mounting device 162 of the embodiment, the first guide surface 172 is formed on the axial inner side of the end cover 111, and the arm portion 165 is elastically deformed by sliding the jaw 177 along the first guide surface 172, so that the arm portion 165 can be easily elastically deformed during assembly, and the convenience of assembly is further improved.

In addition, by making the arm portion 165 be abutted against the snap-fit groove 167 in the direction opposite to the elastic deformation direction of the arm portion, it is possible to restrain the mounting base 113 from shaking in the radial direction with respect to the end cover 111, improve the mounting stability of the brake system 106, and further improve the overall stability of the braking force of the fishing reel.

In the mounting device 162 of the embodiment, the outer periphery surface of the second wall portion 156 of the mounting base 113 and the inner side wall surface 122a of the outer side wall 122 of the end cover 111 are fitted with each other in a state that the second snap-fit portion 166 and the first snap-fit portion 164 are snap-fitted with each other, and the axial end surface of the second wall portion 156 of the mounting base 113 is abutted against the axial inner side of the base portion 121 of the end cover 111. Therefore, the concentricity between the mounting base 113 and the end cover 111 can be improved, and the axial shaking of the mounting base 113 relative to the end cover 111 can be suppressed, so that the mounting stability of the brake system 106 can be improved, and the overall stability of the braking force of the fishing reel can be improved.

Moreover, in the mounting device 162 of the embodiment, by making the snap-fit groove 167 and the jaw 177 have a dimensional relationship of clearance fit with each other, not only can the mounting base 113 be easily mounted to the end cover 111, but also stress concentration on the arm portion 165 of the mounting base 113 can be suppressed. Therefore, the arm portion 165 of the mounting base 113 can be further prevented from cracking.

Moreover, in the mounting device 162 of the embodiment, multiple sealing layers 163 are provided (for example, the first sealing ring 184 and the second sealing ring 185), so that the opening 158 of the mounting cavity 147 of the mounting base 113 can be sealed in all directions.

It should be noted that in the above embodiment, an example in which the snap-fit groove 167 is formed at the end cover 111 as the first snap-fit portion 164 and the jaw 177 is formed in the arm portion 165 as the second snap-fit portion 166 is described, but it is not limited to this. For example, a snap-fit protrusion served as the first snap-fit portion 164 may be formed on the axial inner side of the end cover 111, and correspondingly, the snap-fit groove 167 served as the second snap-fit portion 166 may be formed in the arm portion 165.

In the above embodiment, an example in which the arm portion 165 extends in a cantilever shape from the opening side end surface 179 of the second wall portion 156 of the mounting base 113 is described, but it is not limited to this. For example, the arm portion 165 may be formed on the radial outer side surface of the second wall portion 156 and extend in a cantilever shape along the circumferential direction of the mounting base 113.

In the above embodiment, an example in which the jaw 177 extends from the tail end of the arm portion 165 to the radial outer side of the mounting base 113 in a direction substantially parallel to the radial direction of the mounting base 113 is described, but it is not limited to this. The jaw 177 may also extend from the tail end of the arm portion 165 to the radial inner side of the mounting base 113 in a direction substantially parallel to the radial direction of the mounting base 113. In this example, the second surface 174 of the jaw 177 may be abutted against the second inner side surface 169 of the snap-fit groove 167.

In the above embodiment, an example in which the control panel 116 of the brake system 106 is provided with the braking-dial input portion 117 is described, but it is not limited to this. For example, the brake system 106 may not have the braking-dial control function, and in this case, the connecting shaft 120 connected with the braking-dial input portion 117 is not needed, and the second sealing ring 185 is not required to seal the brake system 106.

Moreover, an example in which the brake system 106 is provided with the cover plate 154 for covering the control panel 116 is described, but it is not limited to this. For example, in the case that the brake system 106 does not have the braking-dial control function, the brake system 106 may not be provided with the cover plate 154 either, and the entire control panel 116 may be directly covered with glue. Therefore, it is also unnecessary to configure, for example, the first sealing ring 184 to seal the brake system 106.

Although the embodiments of the present disclosure have been shown and described, those of ordinary skills in the art may understand that various changes, amendments, substitutions and modifications can be made to these embodiments without departing from the principles and purposes of the present disclosure, and the scope of the present disclosure is limited by the claims and equivalents thereof.

What is claimed is:

1. A device for mounting a brake system of a fishing reel, wherein the fishing reel comprises:
a body;
a first end portion provided with an end cover, wherein the end cover is mounted at an axial end of the body;
a spool portion provided with a spool shaft, wherein an axial end of the spool shaft is rotatably mounted on the end cover; and
a brake system mounted to the end cover, wherein the brake system is provided with a mounting base, a coil, a magnet and a control panel, the mounting base is provided with a mounting cavity, the coil is mounted on the mounting cavity, the magnet is mounted on the spool shaft, and the coil and the magnet are opposite to each other along a radial direction of the spool shaft;
wherein the brake system is mounted to the end cover through the device, and the device comprises:
a plurality of first snap-fit portions arranged at the end cover; and
a plurality of arm portions arranged at intervals in a circumferential direction at an opening of the mounting cavity of the mounting base, wherein each of the arm portions extends from one end of the mounting base in an axial cantilever manner, a second snap-fit portion is provided at a tail end of each of the arm portions, and each second snap-fit portion is elastically snap-fitted with the respective first snap-fit portion.

2. The device for mounting a brake system of a fishing reel according to claim 1, wherein the mounting base is provided with:
an annular first wall portion located at a radial inner side;
an annular second wall portion surrounding a radial outer side of the first wall portion; and
a sealing wall connected with the first wall portion and the second wall portion at a side opposite to the opening in the axial direction;
wherein the first wall portion, the second wall portion and the sealing wall together define the mounting cavity; and
the arm portions are arranged on the second wall portion.

3. The device for mounting a brake system of a fishing reel according to claim 2, wherein a transition groove is provided between each of the arm portions and the second wall portion.

4. The device for mounting a brake system of a fishing reel according to claim 1, wherein each of the first snap-fit portions is a snap-fit groove extending through the end cover in a thickness direction of the end cover;
each of the second snap-fit portions is a jaw at the tail end of the respective arm portion; and
the jaw served as the respective second snap-fit portion passes through the snap-fit groove served as the respective first snap-fit portion and is snap-fitted with the end cover at a side opposite to the mounting base.

5. The device for mounting a brake system of a fishing reel according to claim 4, wherein the snap-fit groove is provided in plural; and
a length of each of the snap-fit grooves is identical to a width of each of the arm portions where the jaw snap-fitted with the snap-fit groove is provided.

6. The device for mounting a brake system of a fishing reel according to claim 4, wherein the end cover is provided with a first guide surface at a side of each of the snap-fit grooves opposite to the mounting base; and
each of the arm portions is elastically deformed by sliding the respective jaw along the respective first guide surface, and is abutted against the respective snap-fit groove in a direction opposite to an elastic deformation direction of the arm portion after the respective jaw passes through the respective snap-fit groove.

7. The device for mounting a brake system of a fishing reel according to claim 1, wherein in a state that each of the second snap-fit portions is snap-fitted with the respective first snap-fit portion, the mounting base and the end cover are abutted against each other at two opposite ends in the axial direction.

8. The device for mounting a brake system of a fishing reel according to claim 2, further comprising:
a sealing layer sealing the opening of the mounting cavity; and
a cover plate accommodated in the mounting cavity and covering the control panel, wherein the cover plate does not protrude from the opening of the mounting cavity;
wherein, the sealing layer comprises a filling layer, the filling layer fills a gap between a circumferential edge of the cover plate and the mounting cavity, and the filling layer does not protrude from the opening of the mounting cavity.

9. The device for mounting a brake system of a fishing reel according to claim 8, wherein one end of the spool shaft passes through the mounting base and the cover plate in the axial direction and is mounted on the end cover;
the first wall portion defines a first avoidance hole allowing the spool shaft to pass through;
a second avoidance hole allowing the first wall portion to be inserted is provided in a middle portion of the cover plate; and
the sealing layer comprises a first sealing ring, and the first sealing ring is arranged between the first wall portion and the second avoidance hole.

10. The device for mounting a brake system of a fishing reel according to claim 8, wherein the control panel is provided with a braking-dial input portion;
the cover plate is provided with a third avoidance hole opposite to the braking-dial input portion;
a connecting shaft for switching a braking-dial switch and connected with the braking-dial input portion passes through the third avoidance hole and is connected with the braking-dial input portion; and
the sealing layer comprises a second sealing ring, and the second sealing ring is arranged between the connecting shaft and the third avoidance hole.
